(19) United States
(12) Patent Application Publication
(10) Pub. No.: US 2026/0161801 A1
(43) Pub. Date: Jun. 11, 2026

(54) COLLECTIVE CONTEXTUAL INTELLIGENCE FOR ENHANCED VULNERABILITY ASSESSMENT AND PENETRATION TESTING

(71) Applicants: REJAH REHIM ANGADITHODIYIL ABDULMAJEED, Trivandrum (IN); PRATHAPACHANDRAN VASUDEVAN

(72) Inventors: REJAH REHIM ANGADITHODIYIL ABDULMAJEED, Trivandrum (IN); PRATHAPACHANDRAN VASUDEVAN

(21) Appl. No.: 19/347,697

(22) Filed: Oct. 1, 2025

Related U.S. Application Data
(60) Provisional application No. 63/701,585, filed on Oct. 1, 2024.

(51) Int. Cl. G06F 21/57

(52) U.S. Cl. CPC G06F 21/577; G06F 2221/034

(57) ABSTRACT

A specially-configured computing system executes a computer-implemented method to improve automated vulnerability-assessment and penetration-testing technology. The system receives heterogeneous security-related data streams including static-analysis results, threat-intelligence feeds, SBOM records, network-telemetry feeds, and cloud-infrastructure information for a protected computing environment. A contextually-adaptive-test-case-selection engine comprising a Bayesian-network model constructs a prioritized list of candidate test-case instructions based on this data and a security-risk model. An adaptive-and-contextual-payload-preparation engine generates tailored attack-payload data structures using contextual information including application-usage patterns and leaked-credential data. An exploit-simulation engine operating under an agentic-artificial-intelligence controller executes multi-step exploit-chain instructions, autonomously adjusting exploit sequences based on runtime-telemetry information. A re-validation module verifies vulnerability indications by correlating telemetry data to suppress false-positives. An SBOM-aware controller updates records with newly-discovered components and triggers additional test-cases. The system transmits test-result records with mitigation recommendations to a DevSecOps-integration subsystem while continuously monitoring zero-day-vulnerability feeds to dynamically trigger further testing.

### CLAIM OF PRIORITY

This application claims priority to U.S. Provisional Patent Application No. 63/701,585, filed on Oct. 1, 2024, and titled COLLECTIVE CONTEXTUAL INTELLIGENCE FOR ENHANCED VULNERABILITY ASSESSMENTAND PENETRATION TESTING. This provisional patent application is hereby incorporated by reference in its entirety.

### BACKGROUND

### Field of the Invention

The present disclosure relates to computer-implemented cybersecurity systems and methods. More particularly, it relates to automated vulnerability assessment and penetration testing using collective contextual intelligence, adaptive test-case selection, contextual payload preparation, and agentic artificial-intelligence-orchestrated exploit simulation.

### Background

Organizations increasingly deploy complex and distributed computing environments that include web applications, application programming interfaces (APIs), cloud services, and on-premises infrastructure. These environments change rapidly as new code, dependencies, and services are introduced. Conventional vulnerability scanners and periodic penetration tests are often unable to keep pace with this dynamic attack surface.

Traditional approaches generally rely on static rule sets, pre-defined payload libraries, and rigid scheduling. As a result, they can generate excessive false positives, overlook context-dependent vulnerabilities, and fail to adapt to real-time discoveries. When applications use single-page frameworks, dynamic client-side logic, or protected endpoints requiring authentication, conventional testing methods frequently provide incomplete coverage. Security teams must also manage heterogeneous information sources, including static analysis reports, dynamic testing outputs, runtime logs, network telemetry, software bill of materials (SBOM) records, and external threat-intelligence feeds. Existing tools typically lack the capability to fuse these diverse streams into a coherent security-risk model that continuously informs testing priorities. Furthermore, validation of findings is often limited, leaving uncertainty about which issues are truly exploitable.

These shortcomings create persistent challenges in coordinating and interpreting multiple security-data sources, selecting and prioritizing test cases in a way that reflects live threat context and organizational risk tolerance, reducing wasted effort caused by irrelevant or redundant payloads, validating exploitability to suppress false positives, and delivering remediation guidance in forms that integrate with existing DevSecOps pipelines.

The disclosed technology addresses these deficiencies by introducing a collective-contextual fusion layer that aggregates heterogeneous data, a contextually adaptive test-case-selection engine that dynamically prioritizes tests using Bayesian reasoning, multi-objective optimization, and active learning, and an adaptive payload-generation framework that tailors exploits to live context. An agentic artificial-intelligence controller orchestrates multi-step exploit simulation, adapts strategies to intermediate telemetry, and supports real-time zero-day triggers. Additional modules perform re-validation of vulnerabilities, update SBOM records with newly discovered components, and generate actionable reports for integration into DevSecOps systems.

Accordingly, the invention improves the functioning of computer-implemented penetration-testing technology itself, providing real-time adaptability, precise exploit validation, and automated remediation support beyond what conventional static or manual approaches can achieve.

### SUMMARY OF THE INVENTION

In one aspect, a computer-implemented method is executed by a specially-configured computing system designed to improve the operation of automated vulnerability-assessment and penetration-testing technology. The method begins when a collective-contextual-fusion layer receives a heterogeneous security-related data stream that comprises multiple types of information, including static-analysis results, interactive-analysis results, dynamic-analysis results, threat-intelligence feeds, dark-web or leak-monitoring feeds, software bill of materials (SBOM) records, network-telemetry feeds, log-data feeds, and cloud-infrastructure information for a protected computing environment.

A contextually-adaptive-test-case-selection engine, which comprises a Bayesian-network model, a multi-objective-optimization module, and an active-learning module, then constructs a prioritized list of candidate test-case instructions based on both the heterogeneous security-related data stream and a security-risk model of the protected computing environment. An adaptive-and-contextual-payload-preparation engine, which is coupled to the contextually-adaptive-test-case-selection engine, generates a tailored attack-payload data structure for each candidate test-case instruction by utilizing contextual information that includes at least application-usage patterns, deployment-environment attributes, leaked-credential data when available, and threat-intelligence data.

An exploit-simulation engine operating under an agentic-artificial-intelligence controller executes a multi-step exploit-chain instruction against the protected computing environment according to the prioritized list and the tailored attack-payload data structure. The agentic-artificial-intelligence controller autonomously adjusts the exploit sequence and payload selection in response to runtime-telemetry information collected from the protected computing environment. A re-validation module then performs a verification step of any vulnerability indication produced by the exploit-simulation engine by correlating the runtime-telemetry information with the log-data feed and the network-telemetry feed to algorithmically suppress false-positive vulnerability indications.

An SBOM-aware controller updates the SBOM record of the protected computing environment with any newly-discovered component and triggers the instantiation of an additional candidate test-case instruction corresponding to the updated SBOM record. The computing system transmits to a DevSecOps-integration subsystem a test-result record of the verification step together with a mitigation recommendation generated by the computing system. Finally, the computing system continuously monitors a zero-day-vulnerability feed and, upon detecting a relevant zero-day disclosure, dynamically triggers execution of a further candidate test-case instruction against a corresponding exposed entry-point of the protected computing environment.

### BRIEF DESCRIPTION OF THE DRAWINGS

The present application can be best understood by reference to the following description taken in conjunction with the accompanying figures, in which like parts may be referred to by like numerals.

FIG. 1 illustrates an example table for Collective Contextual Intelligence for Enhanced Vulnerability Assessment and Penetration Testing (CVEAPT), according to some embodiments.

FIG. 2 illustrates an example process for code analysis, according to some embodiments.

FIG. 3 illustrates an example process for implementing CVEAPT, according to some embodiments.

FIG. 4 illustrates an example process for automated penetration testing with collective intelligence, according to some embodiments.

FIG. 5 illustrates an example process for performing Passive reconnaissance, according to some embodiments.

FIG. 6 illustrates an example process for implementing active reconnaissance, according to some embodiments.

FIG. 7 illustrates an example catcs system, according to some embodiments.

FIG. 8 illustrates an example process for contextually adaptive test case selection for application and API security testing, according to some embodiments.

FIG. 9 illustrates an example process for enhanced threat-aware exploit simulation, according to some embodiments.

FIG. 10 illustrates an example process for re-validation of vulnerabilities, according to some embodiments.

FIG. 11 illustrates an example process for performing root cause identifications, according to some embodiments.

FIG. 12 illustrates an example process for mitigation plan creation and reporting, according to some embodiments.

The Figures described above are a representative set and are not exhaustive with respect to embodying the invention.

### DESCRIPTION

Disclosed are a system, method, and article of manufacture for collective contextual intelligence for enhanced vulnerability assessment and penetration testing. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

The following terminology is used in example embodiments:

Active reconnaissance refers to the direct probing of a target system or network—such as sending packets, scanning ports, enumerating services, or crawling web applications—to gather configuration details and discover potential attack surfaces. Unlike passive reconnaissance, it interacts with the target and can often be detected in logs or by intrusion-detection tools, but it yields more precise, real-time information about live systems.

Agentic AI refers to an artificial-intelligence control layer that can autonomously plan, select, and execute tasks toward a defined goal without continuous human prompting. Within penetration-testing workflows, it orchestrates multi-step attack sequences, adapts payloads to changing context, and adjusts its strategy in response to intermediate results. By reasoning over live telemetry, historical outcomes, and external threat intelligence, Agentic AI improves realism, coverage, and repeatability of security-testing activities.

Bayesian network is a probabilistic graphical model that represents a set of variables and their conditional dependencies via a directed acyclic graph (DAG). It applies Bayes'theorem to infer the likelihood of events or outcomes given evidence from related variables, enabling reasoning under uncertainty. In the CATCS framework, the Bayesian network dynamically updates risk predictions for vulnerabilities as new contextual data, threat intelligence, or test results are introduced, helping prioritize the most probable and impactful attack paths.

Collective Contextual Intelligence for Enhanced Vulnerability Assessment and Penetration Testing (CVEAPT) is a data-driven framework that integrates multiple intelligence streams—such as SAST, IAST, DAST results, threat-intelligence feeds, dark-web monitoring, log analytics, and SBOM data—to form a holistic view of an organization's security posture. It uses machine-learning and, optionally, large-language-model (LLM) inference to correlate these heterogeneous inputs and generate context-rich vulnerability assessments and penetration-testing strategies. By fusing static code issues with live runtime findings and external threat context, CVEAPT prioritizes the most impactful test cases, improves coverage, and reduces false positives during automated penetration testing.

Contextually Adaptive Test Case Selection (CATCS) is an automated framework for selecting and prioritizing security-testing test cases in real time by combining contextual information—such as application usage patterns, deployment environment, and current threat intelligence—with a security-risk model. It leverages adaptive algorithms (for example Bayesian networks, multi-objective optimization, and active learning) to dynamically pick the most relevant test cases and refine them as new data appears during testing. By tailoring test selection to live context, CATCS improves test-coverage efficiency, reduces false positives, and responds quickly to evolving threats such as newly discovered vulnerabilities.

DevSecOps is an augmentation of DevOps to allow for security practices to be integrated into the DevOps approach. Each delivery team can be empowered to factor in the correct security controls into their software delivery. Security practices and testing are performed earlier in the development lifecycle.

Domain Name System (DNS) is the global directory service that converts human-readable domain names (e.g., example. com) into the numeric IP addresses computers use to route traffic.

Dynamic Application Security Testing (DAST) is a black-box testing method that evaluates a running application from the outside-in by simulating external attacks. DAST scanners probe web endpoints, input fields, and exposed APIs for exploitable conditions—such as injection flaws, authentication bypasses, or misconfigurations—without access to the source code. DAST complements SAST and IAST by validating how the live application responds to crafted requests in its deployed environment.

Exploit simulation is the controlled execution of crafted payloads and attack chains that mimic real-world adversary techniques to test whether identified vulnerabilities can be exploited in practice. It allows security teams or automated platforms to validate theoretical weaknesses by safely reproducing multi-stage attack paths—often in sandboxed or monitored environments—without disrupting production services. By confirming exploitability and capturing system responses, exploit simulation improves the accuracy of vulnerability assessments and guides remediation with evidence-based findings.

Fuzzing and mutation operations combine two input-generation techniques for uncovering hidden flaws. Fuzzing automatically feeds large volumes of random, unexpected, or malformed input data to an application to expose crashes, unhandled errors, or security weaknesses. Mutation operations can extend fuzzing by systematically altering valid baseline inputs—such as bit-flips, boundary-value changes, or protocol-field edits—to explore additional edge-case behaviors and potential vulnerabilities.

Large language model (LLM) is a computerized language model consisting of an artificial neural network with many parameters (e.g., tens of millions to billions), trained on large quantities of unlabeled text using self-supervised or semi-supervised learning. An LLM can achieve general-purpose language generation and understanding by learning statistical relationships from text documents during a computationally intensive training process. LLMs can be decoder-only transformer-based or built on alternative architectures such as recurrent-neural-network variants or state-space models.

Machine learning is a type of artificial intelligence (AI) that provides computers with the ability to learn without being explicitly programmed. Machine learning focuses on the development of computer programs that can teach themselves to grow and change when exposed to new data. Example machine-learning techniques that can be used herein include, inter alia: decision-tree learning, association-rule learning, artificial neural networks, inductive-logic programming, support-vector machines, clustering, Bayesian networks, reinforcement learning, representation learning, similarity-and metric-learning, and/or sparse-dictionary learning.

Object-Relational Mapping (ORM) framework is a software layer that maps program-level objects—classes, fields, and relationships—to the tables, columns, and joins of a relational database. By automatically generating the underlying SQL queries and enforcing parameterized interactions, ORMs simplify data-access code, improve maintainability, and reduce the risk of developer-introduced query flaws. In secure-coding contexts, ORMs help mitigate vulnerabilities such as SQL-injection attacks by abstracting low-level query construction and applying consistent input-sanitization rules.

Real-time zero-day triggers are automated mechanisms that detect disclosures or indications of previously unknown (zero-day) vulnerabilities and immediately activate relevant test cases. They continuously ingest threat-intelligence feeds and contextualize new findings against the target environment to determine exploitability. This capability reduces the reaction window from days or weeks to minutes, ensuring that defenses can be assessed as soon as a zero-day vulnerability is discovered.

Static Application Security Testing (SAST) is a white-box testing technique that analyzes an application's source code, bytecode, or binaries without executing the program to detect coding errors, insecure functions, and logic flaws that may lead to vulnerabilities before deployment. SAST scans can be integrated early in the development lifecycle to enforce secure-coding practices and reduce remediation cost by identifying weaknesses at build time.

Zero-day vulnerability refers to a previously unknown flaw or weakness in software, hardware, or a configuration that has not yet been disclosed to or patched by the vendor or owner of the affected system. Because no official fix or mitigation is available at the moment of discovery, zero-day vulnerabilities present an elevated security risk and are often targeted by threat actors immediately after disclosure. Effective security-testing platforms monitor threat-intelligence sources for emerging zero-day reports and can trigger rapid assessment workflows to determine whether the vulnerability is exploitable in the target environment.

These definitions are provided by way of example and not of limitation. They can be integrated into various example embodiments discussed infra.

### Example Methods

The present invention provides a Contextually Adaptive Test Case Selection (CATCS) system for application and API security testing. CATCS leverages adaptive algorithms, contextual information, and security risk models to dynamically select and prioritize test cases based on their potential impact and effectiveness in uncovering vulnerabilities.

The system incorporates Adaptive and Contextual Payload Preparation (ACPP) capabilities. ACPP dynamically generates and adapts payloads based on the security risk model, contextual information, and specific vulnerabilities targeted by the test cases. This further enhances the effectiveness and efficiency of security testing. ACPP is further discussed infra in the description of CATCS system 700 infra.

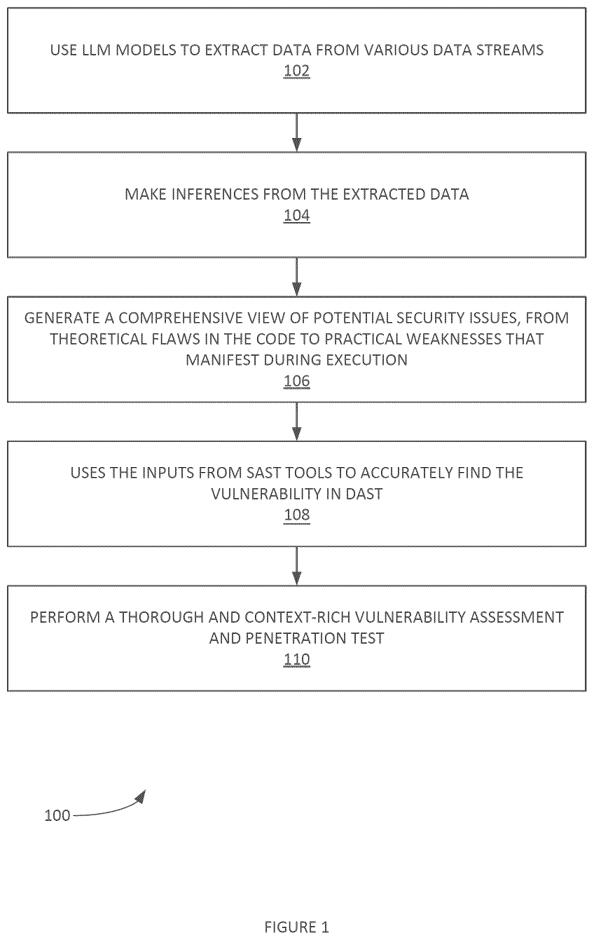

FIG. 1 illustrates an example table 100 for Collective Contextual Intelligence for Enhanced Vulnerability Assessment and Penetration Testing (CVEAPT), according to some embodiments. CVEAPT can refer to a comprehensive, data-driven approach that leverages various streams of information to augment the security testing process. Process 100 can use LLM models to extract data from various streams, It makes this step easy and helps to make inference of the data we crawls. Process 100 can integrate diverse datasets (e.g. see infra) and tools to form a holistic view of an organization's security posture, actively informing testing methodologies and improving precision in identifying and addressing vulnerabilities. By collecting data from both SAST and IAST, the CVEAPT approach provides a comprehensive view of potential security issues, from theoretical flaws in the code to practical weaknesses that manifest during execution. The integration of these tools enables the simultaneous identification of vulnerabilities in both static code and a running application.

More specifically, in step 102, process 100 can use LLM models to extract data from various data streams. In step 104, process 100 can make inferences from the extracted data. In step 106, process 100. In step 108, process 100 uses the inputs from SAST tools to accurately find the Vulnerability in DAST. process 100 performs a thorough and context-rich vulnerability assessment and penetration test in step 110.

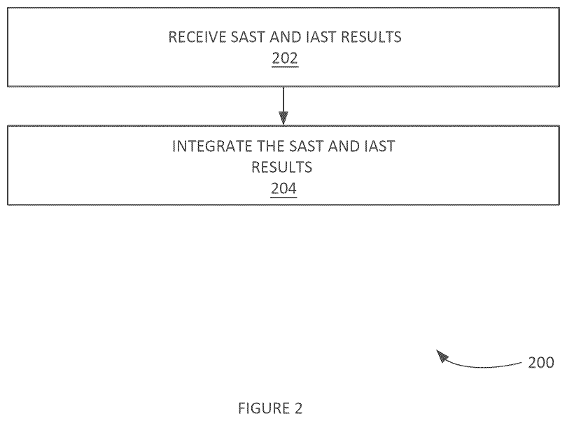

FIG. 2 illustrates an example process 200 for code analysis, according to some embodiments. Process 200 can receive results of both SAST and IAST in step 202. Static Application Security Testing (SAST) works by scanning source code, bytecode, or binary code for issues that may lead to vulnerabilities, without executing the program. Interactive Application Security Testing (IAST) combines aspects of both Static and Dynamic Application Security Testing (DAST), analyzing code for vulnerabilities during its execution or runtime. In step 204, process 200 can integrate the SAST and IAST results.

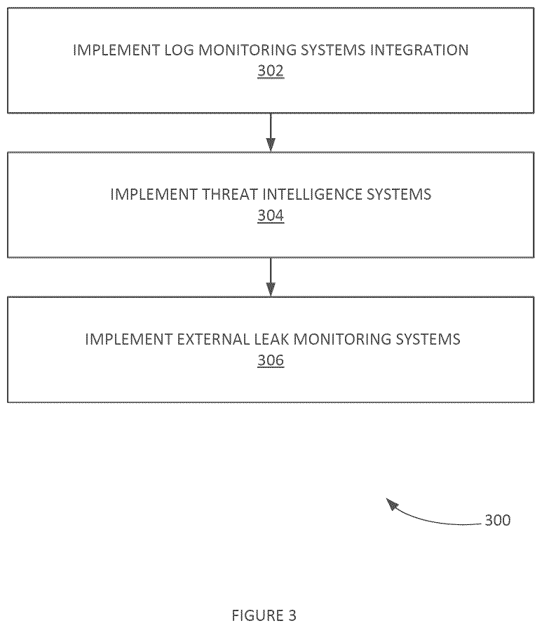

FIG. 3 illustrates an example process 300 for implementing CVEAPT, according to some embodiments. In step 302, process 300 implements log monitoring systems integration. In some embodiments, systems like Datadog provide real-time monitoring of logs, events, and system behavior can be utilized. By analyzing this data, unusual or anomalous patterns can be detected that might indicate a security breach or vulnerability exploitation actively occurring in the system.

In step 304, process 300 implements threat intelligence systems. Here, CVEAPT leverages threat intelligence platforms to stay informed about emerging threats. These platforms provide a contextual understanding of the threat environment by supplying information on new exploits, methodologies used by threat actors, and vulnerability disclosures.

In step 306, process 300 implements external leak monitoring systems. CVEAPT extends its capability by monitoring data leakage on platforms like the dark web. This proactive measure helps in identifying whether any sensitive data or credentials from the organization have been exposed and could potentially be used in targeted attacks.

Inputs to the CVEAPT system now discussed by way of example. It is noted that other example embodiments can include other inputs as well. Example inputs include, inter alia:

Beagle External Event—Pub Sub: This set of data streams forms the basis of the CVEAPT system's external event collection:

Threat Intelligence Streams (STIX/TAXII): Structured frameworks for sharing cyber threat information;

Dark Web Monitoring: Surveillance of hidden websites for stolen data and other illicit activities;

Data Leak Monitoring: Observation of various sources for unintentional data exposures;

GitHub and Other Code Monitoring: Keeping track of public code repositories for potential leaks or security flaws in shared code;

CVE Databases: Comprehensive listings of publicly disclosed cybersecurity vulnerabilities;

Customer Intra-Net EVENT—Pub Sub: The following data streams provide information from within the customer's network;

Crawlers: Human like crawlers scour the heterogeneous applications and APIs;

Cloud Infra Details: Specifics regarding the customer's cloud infrastructure;

Internet Gateway Proxy: Logs traffic details to and from the infrastructure, looking for anomalies and potential threats;

API Discovery (Postman Integration): Uses tools like Postman to discover and test APIs for vulnerabilities;

SBOM Details: A detailed bill of materials that records all components in the software;

SAST Tool Results: Findings from static analysis of application source code;

Network Feeds: Streams of network traffic data that may indicate attempted or successful breaches;

Log Aggregator Details: Consolidated log information from across the customer's digital estate;

Vulnerability Details: Data relating to known vulnerabilities within the environment;

ERP System: Enterprise Resource Planning system information that may unveil flaws or integration points; and

Bug Lists: Documented lists of known bugs and issues in the software or systems.

Returning to process 100, in step 110, the culmination of this information allows the CVEAPT system to perform a thorough and context-rich vulnerability assessment and penetration test. This test can be used to clarify the security landscape, focusing efforts not just on known issues, but also on emerging risks, thus providing a dynamical and informed security testing strategy.

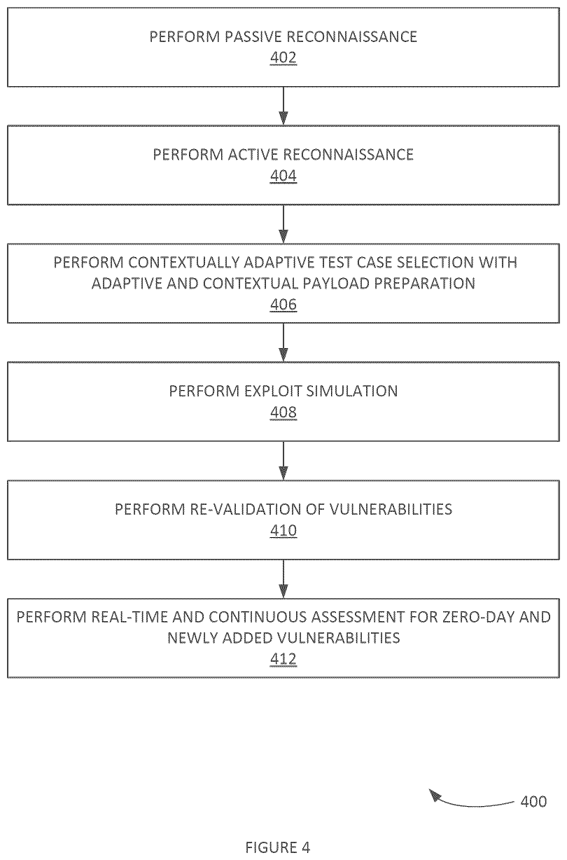

FIG. 4 illustrates an example process 400 for automated penetration testing with collective intelligence, according to some embodiments. In the context of automated penetration testing with collective intelligence, the main steps outline a structured approach to identifying, assessing, and addressing security vulnerabilities within a system. Process 400 can be generally cyclical and iterative, ensuring continuous improvement in security posture.

In step 402, process 400 performs passive reconnaissance. Process 400 gathers intelligence without directly interacting with the target systems. Process 400 utilizes sources like threat intelligence streams, dark web monitoring, and public repositories to collect relevant information for future testing stages.

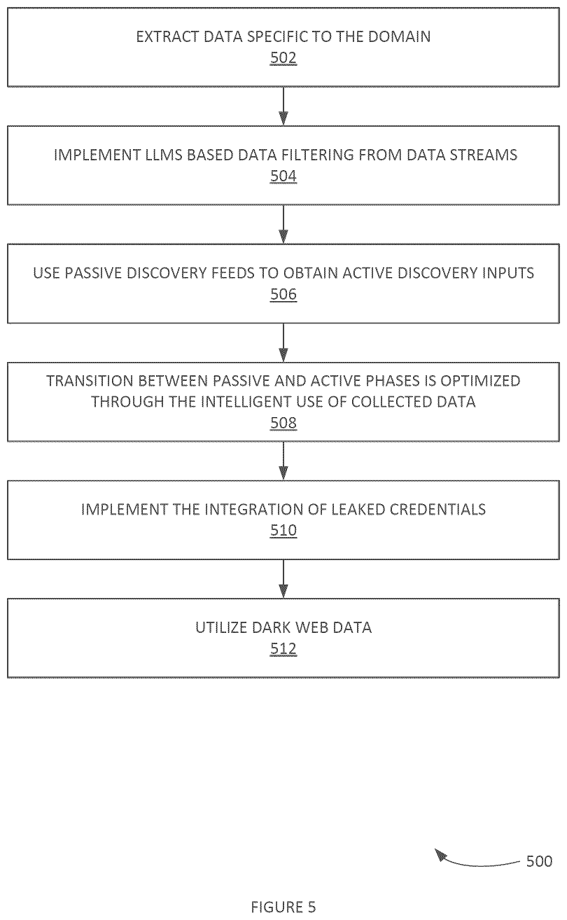

FIG. 5 illustrates an example process 500 for performing Passive reconnaissance, according to some embodiments. From an automated penetration testing perspective, passive reconnaissance steps are performed using automated tools and techniques to gather information without alerting the target system to the tester's presence.

In step 502, process 500 extracts data specific to the domain. This step involves using automated tools to methodically collect publicly available information pertaining to a specific domain without actively engaging with the target's systems. The domain data may include DNS records, domain registration details, and any other publicly posted information. The aim here is to amass a knowledge base about the target that can be used in later stages of the penetration test.

In step 504, process 500 implements LLMs Based Data filtering from data streams. Instead of conventional parsing methods to sift through data, a Large Language Model can be employed. This AI-driven approach allows for the extraction of relevant information from vast and varied data sources by understanding the context of the information rather than just matching patterns. LLMs are particularly effective because they can interpret nuances in human language and therefore can pull out specific security-related data points from large datasets without the need for explicit parsing rules.

In step 506, process 500 uses passive discovery feeds to obtain active discovery inputs. Following the passive reconnaissance phase, the accumulated and processed data serves as strategic input for the subsequent active phase, which is also managed by the automated system. During active reconnaissance, process 500 proactively engages with the target to uncover vulnerabilities, leveraging insights such as potential entry points and system specifics garnered from passive discovery. This ensures that the automated system's active probing is both efficient and focused, cutting down on extraneous activity that could raise suspicions, thereby streamlining the identification of exploitable weaknesses while maintaining a low profile.

The transition between passive and active phases is optimized through the intelligent use of collected data in step 508.

In step 510, process 500 implements the integration of leaked credentials. During passive reconnaissance, the automated system might discover leaked credentials (e.g. usernames and passwords) associated with the target organization. These credentials can have been exposed through various means like data breaches, and finding them on forums, paste sites, or other locations on the dark web is often possible without direct interaction with the target's systems. Once discovered, these credentials can be invaluable during active discovery, where they may be used to test login systems, access controls, and potentially escalate privileges within the target network.

In step 512, process utilizes dark web data. Information from the dark web can include details about known vulnerabilities, exploits, or other security incidents related to the target. An automated system that scans and monitors the dark web for such intelligence can use this data to better understand the threat landscape specific to the target. For example, if an exploit code is mentioned in connection with the target's technology stack, the active discovery process can prioritize testing for that particular vulnerability.

By using the rich contextual data gathered during passive reconnaissance—like leaked credentials and dark web intelligence—the automated system performing process 500 can tailor its active scanning and testing processes. This leads to a more efficient and effective penetration testing, potentially increasing the chances of identifying critical vulnerabilities by testing specific scenarios that have a higher likelihood of being successful, based on the insights gained from passive discovery efforts.

Returning to process 400, in step 404, process 400 performs active reconnaissance: Process 400 engages in active scanning and probing of the target systems to enumerate services, configurations, and vulnerabilities. This phase uses insights from passive reconnaissance to focus the efforts on likely points of weakness with minimal alerting of the target systems.

Active reconnaissance, in the context of an automated penetration testing system, employs the intelligence gathered during the passive phase—including leaked credentials and other collected data—to enhance the efficacy of system exploration or “crawling.”

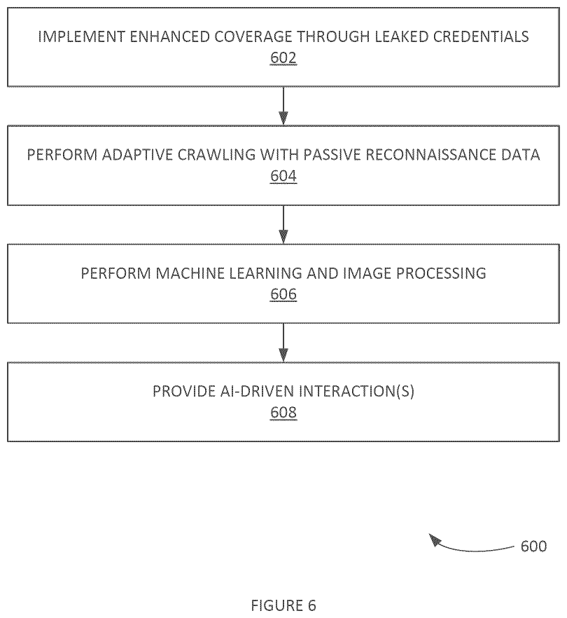

FIG. 6 illustrates an example process 600 for implementing active reconnaissance, according to some embodiments.

In step 602, process 600 implements enhanced coverage through leaked credentials. Utilizing leaked credentials discovered during passive reconnaissance, the automated system performing process 600 can attempt to access protected areas of the target's systems that might otherwise be inaccessible. This helps in expanding the scope of the crawl to include sections of the site that require authentication, allowing for a more comprehensive examination of the target.

In step 604, process 600 performs adaptive crawling with passive reconnaissance data. The automated system performing process 600 dynamically uses the insights from passive reconnaissance to adapt its crawling strategy. This can be a type of adaptive crawling. Adaptive crawling enables the system to mimic human navigation through the use of advanced algorithms and machine learning. By identifying entry points, including form fields, and systematically testing these areas for vulnerabilities, the system can probe deeper into the application.

In step 606, process 600 performs machine learning and image processing. Adaptive crawling takes advantage of machine learning and image processing to interact with web applications in a more human-like manner. Process 600 can recognize and interpret visual elements such as buttons, fields, and menus, even within sophisticated single-page applications that are heavily reliant on JavaScript. This approach allows for the automated system to interact with the application as a user might, navigating through client-side logic and AJAX calls that traditional crawlers might miss.

In step 608, process provides AI-Driven Interaction(s). Process 600 can use an AI engine. The AI-engine identifies these interactive elements and also intelligently fills out forms and navigates through links and buttons, accommodating any dynamic changes in the application's state. Process 600 can use this to evaluate security in modern web applications, where user interaction can trigger numerous state changes and potential security issues may only manifest through active engagement with the application.

In summary, active reconnaissance guided by automated systems is highly sophisticated, employing leaked credentials and passive data to inform an adaptive crawling strategy. Process 600, powered by machine learning and AI, ensures thorough exploration and assessment of web applications, including complex JavaScript-based single-page applications, for potential vulnerabilities.

In step 406, process 400 performs contextually adaptive test case selection with Adaptive and Contextual Payload Preparation. Dynamically select and prepare test cases for execution based on a variety of contextual factors such as application usage patterns, infrastructure details, and the current threat landscape. Employ an automated system for intelligent test case selection and uses adaptive algorithms for crafting effective payloads.

In step 408, process 400 performs exploit simulation. Process 400 can craft and execute exploits based on the prioritized test cases, simulating real-world attack scenarios. It leverages both internal exploit databases and real-time inputs, such as zero-day disclosures or threat-intelligence feeds, to create a realistic testing environment. Agentic AI is used to orchestrate and automate portions of the simulation by autonomously selecting and tailoring exploit chains, coordinating multi-step attack sequences, adapting payloads to target context, and responding to intermediate results, thereby increasing realism, coverage, and repeatability of the simulated attacks.

In step 410, process 400 performs re-validation of vulnerabilities. Process 400 uses the data from logs and network details to re-validate the identified vulnerabilities, with a focus on identifying and removing any false positives. This process ensures that the identified issues are genuine and actionable. Agentic AI augments re-validation by automatically correlating telemetry, prioritizing verification steps, proposing likely false-positive candidates, and adapting re-validation workflows based on observed evidence, speeding triage and improving the accuracy of final vulnerability determinations.

In step 412, process 400 performs real-time and continuous assessment for zero-day and newly-added vulnerabilities. Process 400 maintains a pro-active stance by continuously assessing the target system for newly emerging threats, including zero-day vulnerabilities. The automated system integrates these assessments into the testing cycle in real-time to ensure that the system's defenses can be immediately evaluated and fortified against new threats. Agentic AI enhances this capability by autonomously monitoring external threat-intelligence feeds, adapting detection strategies as new exploit patterns emerge, and orchestrating continuous validation workflows without requiring manual intervention. By dynamically adjusting to evolving threat landscapes, Agentic AI ensures that assessments remain both current and comprehensive.

Through these steps, automated penetration testing becomes a more strategic, responsive, and effective tool for strengthening an organization's cybersecurity posture. It allows for continual improvement of security measures, adaptation to the evolving threat landscape, and ensures ongoing protection against both known vulnerabilities and newly discovered threats.

The processes (e.g. processes 100-600, etc.) provided herein can be used for contextually adaptive test case selection with adaptive and contextual payload preparation. This method emphasizes real-time adaptation of security testing procedures, targeting web applications and APIs based on up-to-date contexts. Test case selection is dynamically driven by both the asset inventory and vulnerability insights, with a continuously evolving Software Bill of Materials (SBOM) that integrates newly discovered information during testing. Any amendments within the SBOM prompt the instantiation of pertinent test scenarios.

Moreover, a system implementing processes 100-600 remains vigilant against emergent threats by incorporating real-time threat intelligence. The moment a new Zero-Day vulnerability is disclosed, or updates surface in vulnerability databases, the system responds by initiating appropriate test cases for applications specially equipped for immediate penetration testing.

This innovation advances the practice of web application and API security testing by replacing static, conventional techniques with a responsive framework that harnesses contextual data and evolving risk profiles. Traditional methods, often hampered by rigid and outdated data, give way to a dynamic solution capable of crafting specialized payloads that keenly target identified vulnerabilities, ensuring a more thorough and efficient security evaluation.

Traditional test case selection and payload preparation methods often rely on static data and models, leading to inefficiencies, subjective biases, and incomplete test coverage. Additionally, payloads are often pre-defined and lack adaptability to the specific vulnerabilities and attack scenarios under investigation.

### Example Systems

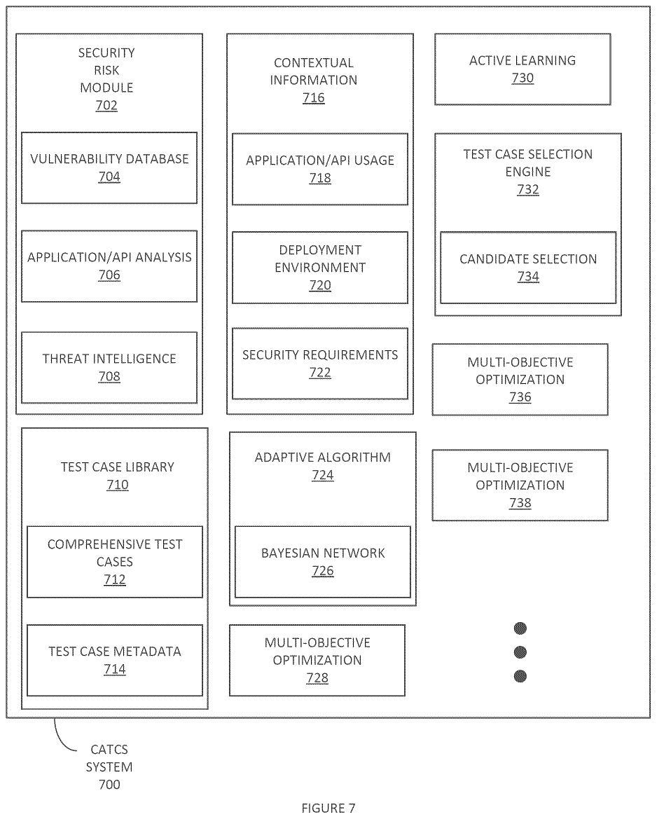

FIG. 7 illustrates an example CATCS system 700, according to some embodiments. CATCS system 700 comprises the following components that are now discussed. CATCS system 700 includes Security Risk Module 702. Security Risk Model 702 includes a Vulnerability Database 704. Vulnerability Database 704 is a comprehensive database of known vulnerabilities and their associated exploit techniques. Security Risk Model Module 702 analyzes vulnerabilities, application/API characteristics, and threat intelligence to generate a dynamic risk profile.

Application/API Analysis 706 performs automated analysis of application/API code, configuration, and architecture to identify potential attack surfaces. Threat Intelligence 708 manages integration with threat intelligence feeds to understand the latest threats and vulnerabilities targeting similar applications/APIs.

Test Case Library 710 manages and stores a comprehensive collection of diverse test cases with associated metadata. Comprehensive Test Cases 712 is a curated collection of diverse test cases covering various security testing methodologies (e.g., penetration testing, fuzz testing, vulnerability scanning).

Test Case Metadata 714 provides that each test case is enriched with metadata describing its target vulnerabilities, attack types, and potential impact based on the context of the vulnerability. Contextual Information 716 gathers and analyzes data on application/API usage, deployment environment, and security requirements.

Application/API Usage 718 performs analysis of application/API usage patterns and user behavior to identify critical functionalities and potential attack scenarios. Deployment Environment 720 implements consideration of the application/API deployment environment, including operating systems, network configurations, and external dependencies.

Security Requirements 722 manages integration with the organization's security requirements and risk tolerance levels to prioritize test cases based on their alignment. Adaptive Algorithm 724 employs Bayesian networks, multi-objective optimization, and active learning techniques to select and prioritize test cases based on the combined input from other modules.

Bayesian Network 726 provides a probabilistic reasoning model that learns and adapts based on the security risk model, test case library, and contextual information. In the context of automated penetration testing, a Bayesian Network serves as a dynamic model that helps in making informed decisions on potential security threats. It uses probabilistic reasoning to assess and prioritize risks based on past data (e.g. security risk models), known vulnerabilities (test case library), and specific variables related to the system being tested (e.g. contextual information).

During a penetration test, this network would analyze the likelihood of different attack vectors succeeding by considering various factors such as the complexity of the attack, the configuration of the target system, and historical security incident data. By continuously learning from new data, the Bayesian Network adapts its understanding of the security landscape to predict and identify potential weaknesses more accurately.

This adaptive learning capability ensures that as the system under test evolves, or new threats are identified in the cybersecurity domain, the penetration testing process remains robust and reflective of the current threat environment. Consequently, the automated penetration testing system can efficiently prioritize testing efforts on the most probable and impactful security vulnerabilities, thus enhancing the effectiveness and efficiency of security assessments.

CATCS system 700 can also include a Feedback Integration Module that allows exploit stimulation engine to provide feedback on test case effectiveness and discovered vulnerabilities, which is incorporated into the adaptive algorithm for continuous improvement.

Multi-Objective Optimization 728 optimizes test case selection based on multiple objectives, including coverage of vulnerabilities, risk reduction, and resource efficiency. Active Learning 730 interactively solicits feedback from exploit simulation module to improve the model's accuracy and effectiveness.

Test Case Selection Engine 732 generates and presents a prioritized list of test cases for exploit simulation based on their potential impact, risk reduction, and resource efficiency. This is a continuous process that can be run until no new testcases cannot be identified.

Candidate Selection 734 identifies a subset of relevant test cases from the library based on the security risk model and contextual information.

CATCS system 700 can implement prioritization methods that rank the candidate test cases based on their potential impact, likelihood of uncovering vulnerabilities, and cost-effectiveness. CATCS system 700 can implement recommendation methods. Here system 700 recommends a prioritized list of test cases to test cases execution or exploit engine for execution. Test selection can tune automatically in Realtime using inputs from any external threats and exploit simulation.

CATCS system 700 intelligently adapts its test selection in real-time. When the test engine detects a new framework or identifies a fresh entry point, it dynamically queues relevant test cases targeting these specific components. Furthermore, the discovery of new URLs or the detection of novel database usage (e.g. perhaps deduced from error messages or during the review of web pages, etc.) triggers the addition of targeted test cases tailored to these findings.

This ensures that the security testing is not only reactive but also proactive, expanding its coverage to include newly identified potential attack surfaces. CATCS system 700 provides agility in incorporating new data into its testing strategy enhances the effectiveness of the overall penetration testing, as it keeps pace with the evolving nature of the system it is protecting, remaining vigilant against the latest vulnerabilities and exposures.

As the Bayesian Network processes real-time data about emerging threats (e.g. external threats) and learns from simulations that mimic hacker attacks (e.g. exploit simulation), it refines its understanding of which vulnerabilities are most likely to be exploited. This constant tuning allows the penetration testing framework to select and prioritize the most relevant tests for the current security context.

The implication is that the automated testing system is not static; it does not rely on a fixed set of tests that could become outdated as new threats emerge. Instead, it actively incorporates the latest threat information and results from continuous exploit simulations to ensure that its test battery is always aligned with the actual risk landscape. This results in a more accurate and effective penetration testing process that provides up-to-date security assessments to protect against current and potential cyber threats.

CATCS system 700 can implement test case selection. Priority logic can be utilized. This can include determining a likelihood of the exploitability and impact and Context of the vulnerability, Factors including the severity of the threat.

CATCS system 700 implement an adaptive and contextual payload preparation. CATCS system 700 can tailor payloads to specific vulnerabilities and attack scenarios. The ACPP uses the security risk model to identify the vulnerabilities targeted by each test case and then generates payloads that are specifically designed to test the exploitability of those vulnerabilities.

CATCS system 700 can adapt payloads to context For example, the ACPP considers contextual information such as application/API usage patterns, deployment environment, leaked data, user details and security requirements to further refine the payloads and make them more effective in the specific testing scenario.

CATCS system 700 can minimize false positives. ACPP focuses on generating payloads that are likely to trigger vulnerabilities while minimizing the generation of irrelevant or ineffective payloads, reducing the risk of false positives as the exploit engine could simulate the attack without compromising the system.

Adaptive and Contextual Payload Preparation components by CATCS system 700 is now discussed. The Adaptive and Contextual Payload Preparation framework within an automated penetration testing system comprises several sophisticated components designed to enhance the testing process.

CATCS system 700 can include a Vulnerability Analysis Engine. Vulnerability Analysis Engine scrutinizes targeted vulnerabilities alongside their exploitation methods, extracting crucial parameters and attack vectors to establish a foundation for tailored attacks.

CATCS system 700 can include Contextual Data Integration. Contextual Data Integration can be used to augment the precision of attacks, it assimilates a variety of contextual details, including application or API usage patterns, user behaviors, exposed credentials, sensitive user information, technology stack insights, programming language specifics, and network architecture.

CATCS system 700 can include Payload Generation Algorithm. Payload Generation Algorithm leverages the power of machine learning, this algorithm synthesizes bespoke initial payloads using a repository of exploit templates, ensuring relevance to both the identified vulnerability and the application context.

CATCS system 700 can perform Fuzzing and Mutation operations to expand the attack surface, initial payloads undergo a series of fuzzing and mutation processes, probing for vulnerabilities with a broader spectrum of variant inputs and potential attack pathways.

CATCS system 700 can perform Payload Validation and Refinement. In its final stage, generated payloads are meticulously validated and honed. Feedback from security tests, the underlying security risk model, and contextual intelligence all feed into refining the attack strategies for maximum efficacy.

CATCS system 700 can provide Improved Test Coverage. CATCS system 700 can dynamically identify and prioritize the most relevant test cases, leading to more comprehensive vulnerability detection. CATCS system 700 can provide reduced testing effort. Here, CATCS system 700 can optimize test case selection and prioritization, saving time and resources.

CATCS system 700 can provide enhanced security posture. CATCS system 700 can provide focuses testing efforts on high-risk areas and potential vulnerabilities, leading to a quicker identification and remediation of security flaws. CATCS system 700 can provide adaptability to change. CATCS system 700 can continuously updates and adjusts based on new vulnerabilities, evolving threats, and changing contexts.

CATCS system 700 can provide improved efficiency. ACPP automates payload generation and adaptation, saving time and resources for security testers. CATCS system 700 can provide increased adaptability. CATCS system 700 can use ACPP can adapt to changing contexts and vulnerabilities, ensuring effectiveness in dynamic environments. Enhanced Vulnerability Detection: Tailored payloads are more likely to trigger vulnerabilities and reveal critical security flaws.

CATCS system 700 can provide reduced false positives. CATCS system 700 can provide focused payload generation reduces unnecessary testing effort and minimizes false alarms. The proactive security measure within automated penetration testing systems that allows for the immediate testing of system entry points when new, previously unknown vulnerabilities (zero-day vulnerabilities) are discovered or when specific test cases for such vulnerabilities are developed.

In this scenario, the penetration testing system is continuously monitoring for threats. As soon as it detects a zero-day vulnerability—meaning a vulnerability that is not yet widely known or for which a patch has not been issued—it promptly generates or identifies a test case specific to that threat. It then proceeds to test all relevant system entry points using this test case. This rapid response capability ensures that the system's security can be assessed and potentially reinforced before attackers have the opportunity to exploit the newfound vulnerability. This feature of the testing system significantly reduces the window of opportunity for attackers to leverage zero-day vulnerabilities by ensuring that security measures can respond in real time to emerging threats.

The CATCS system 700 provides a novel and efficient approach for test case selection in application and API security testing. CATCS system 700 offers significant improvements in test coverage, testing efficiency, and overall security posture. CATCS system 700 represents a significant advancement in the field of application and API security testing. By leveraging adaptive algorithms, contextual information, and a comprehensive security risk model, CATCS enables organizations to select and prioritize test cases more effectively, leading to improved vulnerability detection, reduced testing effort, and a stronger overall security posture. As security threats continue to evolve, CATCS provides a valuable tool for organizations to safeguard their critical applications and APIs in a dynamic and ever-changing environment.

### Additional Discussion

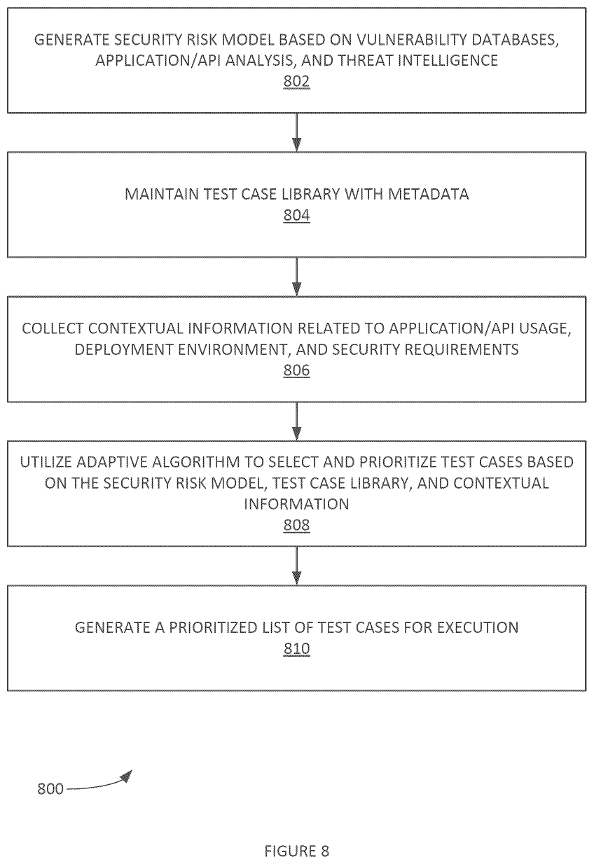

FIG. 8 illustrates an example process 800 for contextually adaptive test case selection for application and API security testing, according to some embodiments. In step 802, process 800 generates a security risk model based on vulnerability databases, application/API analysis, and threat intelligence. In step 804, process 800 maintains a test case library with metadata. A Test Case Library Module manages and stores a comprehensive collection of diverse test cases with associated metadata. In step 806, process 800 collects contextual information related to application/API usage, deployment environment, and security requirements. In step 808, process 800 utilizes an adaptive algorithm to select and prioritize test cases based on the security risk model, test case library, and contextual information. In step 810, process 800 generates a prioritized list of test cases for execution.

The adaptive algorithm can include a Bayesian network, multi-objective optimization, and active learning techniques. The contextual information can include data on user behavior, network configurations, application/API stack, Development language, and security requirements. The payload generation algorithm can utilize machine learning techniques and exploit templates.

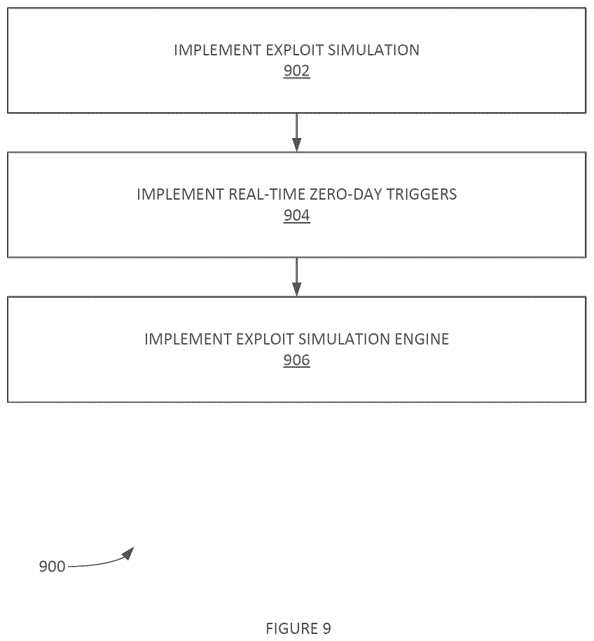

FIG. 9 illustrates an example process 900 for enhanced threat-aware exploit simulation, according to some embodiments. In step 902, process 900 implements exploit simulation. Exploit simulation can be a pivotal aspect of penetration testing systems, aimed at proactively identifying and addressing security weaknesses before they are maliciously targeted. This simulation process goes beyond traditional penetration testing by integrating advanced technologies to improve precision and adapt to emerging threats. Agentic AI augments exploit simulation by autonomously selecting, sequencing, and adapting exploit strategies in real-time, leveraging contextual awareness of the target environment, live threat intelligence, and prior simulation outcomes. By dynamically orchestrating multi-stage attack paths and refining payloads based on observed responses, Agentic AI ensures that exploit simulations more accurately reflect real-world adversarial behaviors.

In step 904, process 900 implements real-time zero-day triggers. When a new zero-day issue is discovered that is, a vulnerability that is not yet publicly known or for which there is no patch the system immediately triggers test cases relevant to this vulnerability. This activation happens in real-time, ensuring that the newly uncovered vulnerability is evaluated as quickly as possible for potential exploitability within the system. Agentic AI strengthens this process by autonomously ingesting zero-day intelligence from diverse sources, contextualizing the relevance of the disclosure to the target environment, and generating or adapting test cases on demand. By dynamically orchestrating trigger workflows and continuously refining them based on real-time feedback, Agentic AI ensures that zero-day vulnerabilities are rapidly and accurately assessed without requiring manual configuration.

In step 906, process 900 implements an exploit simulation engine. This component executes the planned exploits against the system, leveraging the available vulnerability list in the database. The exploit simulation accepts real-time inputs, allowing for the assessment of exploitability and subsequent notification regarding zero-day issues. Execution of exploits can confirm whether vulnerabilities are viable attack vectors, which informs the necessary action plans for mitigation. Agentic AI augments the exploit simulation engine by autonomously selecting and sequencing exploit chains, tuning payloads and timing to target context, and adapting strategies in response to observed system behavior. It can orchestrate multi-stage attack paths, sandbox and rollback state to limit operational impact, correlate runtime telemetry with prior simulation outcomes, and automatically escalate confirmed findings into verification and remediation workflows thereby improving accuracy, repeatability, and safety of exploit validation.

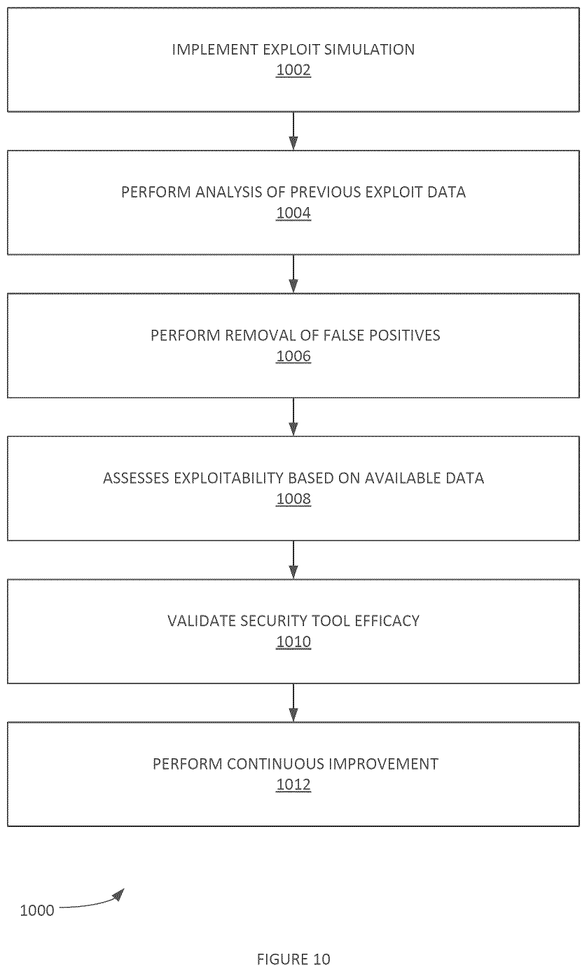

FIG. 10 illustrates an example process 1000 for re-validation of vulnerabilities, according to some embodiments. Re-validation of vulnerabilities is an essential process in ensuring that the identified security issues are indeed genuine and not false positives. In this context, re-validation takes the insights gathered from exploits and cross-references them against logs and network details to confirm the accuracy of the vulnerabilities detected. Here is how the re-validation logic works:

In step 1002, process 1000 provides access to logs and network details. The system is provided with comprehensive logs, which could include application logs, security logs, network traffic logs, and any other relevant data that reflects the events occurring within the system. Network details might encompass configurations, current state, network traffic, and more. This data provides a basis for understanding the actual behavior of the system during and after the exploit attempts.

In step 1004, process 1000 performs analysis of previous exploit data. By referencing large datasets that contain the outcomes of previous exploit simulations, the system can compare new findings against historical patterns. It can identify whether a particular alert is consistent with a genuine vulnerability or resembles a known false positive signature.

In step 1006, process 1000 perform removal of false positives. Using historical data and the insights obtained from the vast test data available, process 1000 can differentiate between true vulnerabilities and anomalies that appear to be vulnerabilities but, upon further analysis, do not present a genuine threat. For example, if an alert is triggered but there is no corresponding evidence of abnormal behavior or unauthorized access in the logs, it may be marked as a false positive.

In step 1008, process 1000 assesses exploitability based on available data. Re-validation not only filters out noise from false positives but also assesses the exploitability of potential vulnerabilities by looking at actual network and application behavior. For instance, if an exploit is presumed to provide unauthorized access to data, logs showing access patterns can be analyzed to confirm or refute that such an event occurred.

In step 1010, process 1000 validates security tool efficacy. Through the re-validation process, organizations can measure the effectiveness of their security tools and configurations. If an exploit is simulated and the security tools fail to either prevent or detect the activity, the tools'efficacy is in question. Conversely, if the tools successfully mitigate or alert upon the simulated attack, it indicates robustness in the security implementation.

In step 1012, process 1000 performs continuous improvement. As the re-validation process identifies false positives and helps fine-tune the understanding of real threats, it becomes part of a cycle of continuous improvement. It helps to refine detection methods, update risk assessment models, and improve the security posture of the organization over time.

In the context of automated penetration testing and contextually adaptive test case selection, re-validation of vulnerabilities is a necessary step that feeds back into the overall testing process. By confirming which vulnerabilities are legitimate and which are false positives, the system can refine its focus, direct resources more efficiently, and provide the organization with a more accurate assessment of their current security state. This process is also crucial for validating that zero-day and other emerging threats are actual vulnerabilities that require immediate attention. Through the re-validation process, an organization can trust the integrity of its security testing results and ensure that remediation efforts are precisely targeted and effective.

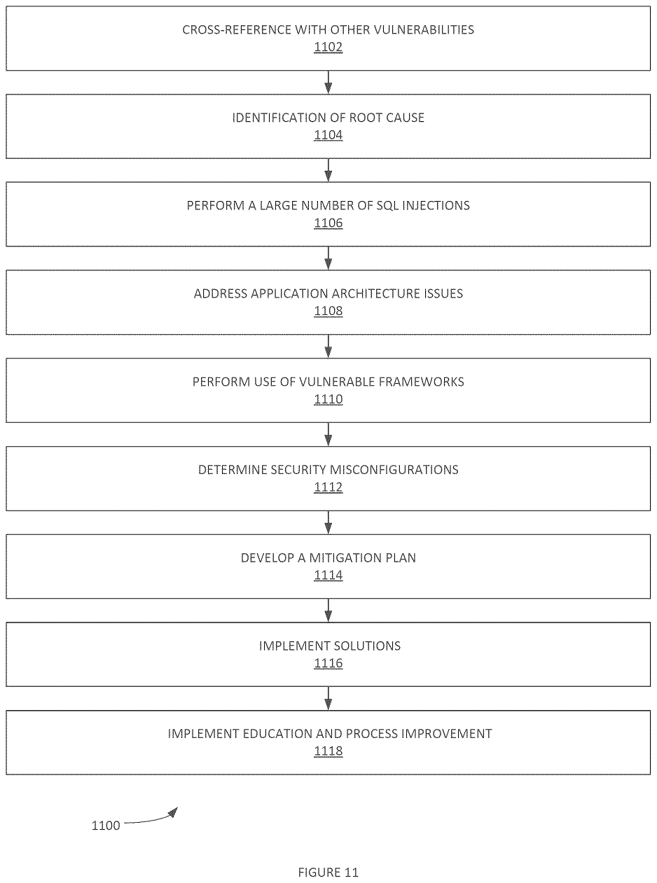

FIG. 11 illustrates an example process 1100 for performing root cause identifications, according to some embodiments. Root cause identification is a crucial step in the vulnerability management process. It involves going beyond the surface-level symptoms of security issues to uncover the underlying factors that contribute to the vulnerabilities. This deeper insight allows organizations to implement more effective and permanent solutions rather than merely addressing the symptoms. Process 1100 works in the context of rooting out the core issues behind detected vulnerabilities.

In step 1102,process 1100 performs cross-reference with other vulnerabilities. When a vulnerability is detected, it is cross-checked against a database of reported and verified vulnerabilities. This comparison helps identify patterns or recurring security issues that share a common cause. These patterns might suggest systemic issues within the environment or application that need to be addressed.

In step 1104,process 1100 performs identification of root cause. A root cause can be different from the immediately apparent vulnerability. It is the fundamental deficiency within the system that allows vulnerabilities to exist or be exploited. Pinpointing it requires a thorough analysis of the vulnerability instances, the architecture, and configurations of the systems and applications involved. In an old SSL version, multiple security issues can stem from an outdated SSL version - deprecated ciphers, protocol-based vulnerabilities, etc.

In step 1106,process 1100 performs a large number of SQL injections. A consistent pattern of SQL injection vulnerabilities may indicate an architectural problem, such as the absence of an Object-Relational Mapping (ORM) framework, which provides a more secure way of interacting with databases.

In step 1108,process 1100 addresses application architecture issues. Structural issues in application design, such as improper input validation or lack of secure coding practices, can create systemic vulnerabilities.

In step 1110, process 1100 performs use of vulnerable frameworks. Relying on old or unmaintained frameworks can inherently increase risk as these may contain unpatched vulnerabilities or do not follow modern security practices.

In step 1112, process 1100 determines security misconfigurations. Varied issues might arise due to improper configuration settings, like open ports, default credentials, or incorrect permission settings.

In step 1114, process 1100 develops a mitigation plan. Once the root cause has been identified, a specific mitigation plan can be developed to address the core issue rather than just treating the individual vulnerabilities. This plan should include both immediate fixes for the vulnerabilities and long-term strategies to prevent similar issues from arising in the future.

In step 1116, process 1100 implements solutions. Solutions may involve upgrading software to the latest versions, changing how applications handle database queries (e.g. implementing prepared statements or ORM), revising application architectures, replacing vulnerable frameworks, and correcting misconfigurations that lead to security gaps.

In step 1118, process 1100 implements education and process improvement. Often, the root cause can be traced back to human factors such as lack of knowledge or inadequate processes. Process 1100 performs educating the developers about secure coding practices, updating development processes to include security reviews, and fostering a culture of security awareness throughout the organization are critical aspects of addressing human-related root causes.

By identifying and addressing the root causes of vulnerabilities, organizations not only solve the immediate problem but can also bolster their security infrastructure against a broad range of potential threats. This systemic treatment of security issues is more effective in the long run and leads to a more resilient and robust security stance. Process 1100 also utilizes a proactive approach that anticipates and mitigates risks rather than responding to them as they become apparent.

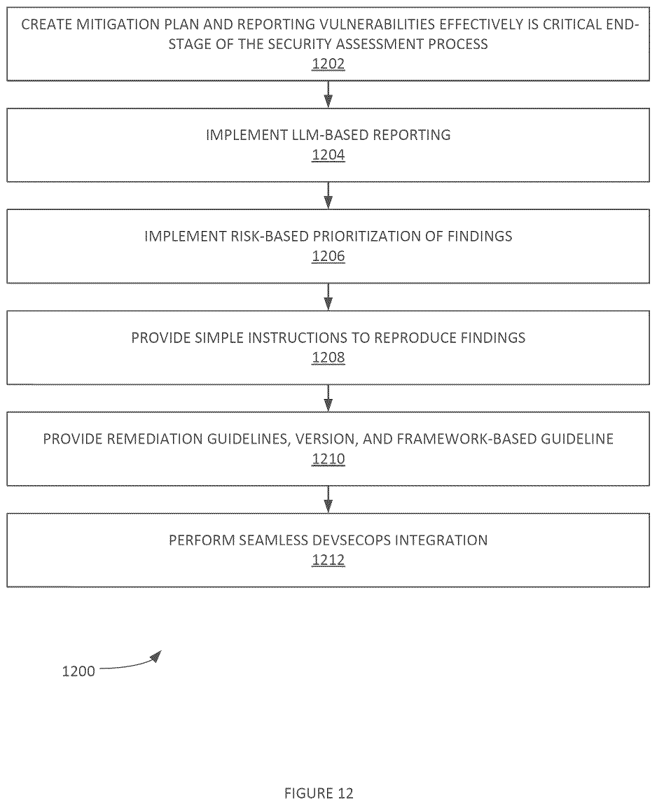

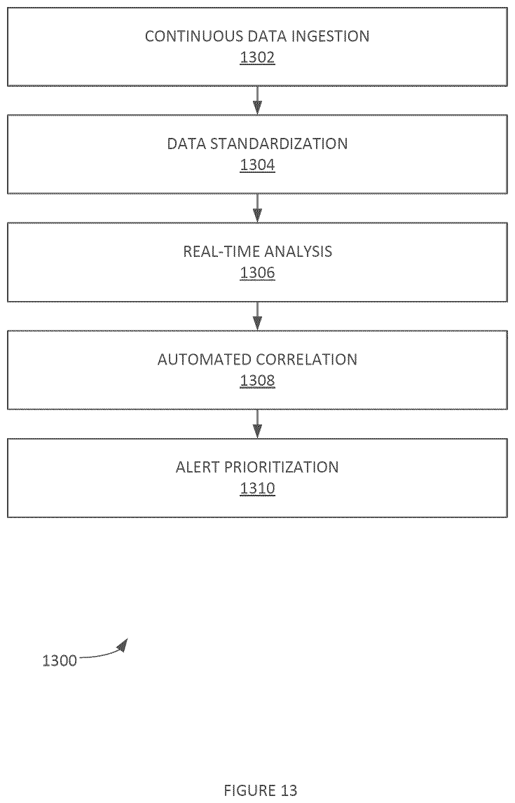

FIG. 12 illustrates an example process 1200 for mitigation plan creation and reporting, according to some embodiments. In step 1202, process 1200 creates a mitigation plan and reporting vulnerabilities effectively is a critical end-stage of the security assessment process. It involves not only identifying the issues but also communicating them in a way that enables developers and security teams to address them efficiently. The role of Large Language Models (LLMs) is instrumental in enhancing the reporting process by providing intelligent insights and automating parts of the documentation. Here's how LLM-based reporting would work in this context:

In step 1204, process 1200 implements LLM-based Reporting. Utilizing LLMs, the reporting system can automatically generate detailed and comprehensible reports on the identified vulnerabilities. LLMs can analyze and summarize vulnerability data, prioritize issues based on risk, and articulate them in a developer-friendly manner. They can also provide easily understandable narratives that explain the nature of the vulnerabilities, their potential impact, and possible attack scenarios.

In step 1206, process 1200 implements risk-based prioritization of findings. Leveraging the capabilities of LLMs, process 1200 can perform a risk-based assessment to prioritize vulnerabilities. It takes into account factors such as the severity of the vulnerability, the complexity of potential exploits, and the importance of the affected system components. These factors are used to rank vulnerabilities, ensuring that critical issues are addressed first.

In step 1208, process 1200 provides simple instructions to reproduce findings (e.g. as actionable insights). The reports generated can offer clear and concise steps to reproduce the findings. This means providing actionable insights that outline exactly where the vulnerability exists, how it can be exploited, and under what conditions. These instructions enable security teams and developers to quickly understand and verify the issues, thereby facilitating a swift response.

In step 1210, process 1200 provides remediation guidelines, version, and framework-based guideline. Based on the Software Bill of Materials (SBOM) details already in hand, the LLM can provide tailored remediation guidelines that are specific to the versions and frameworks used in the system. For example, if a vulnerability is found in a particular version of a framework, the LLM-based report can include instructions specific to that version for patching or otherwise mitigating the issue.

In step 1212, process 1200 performs seamless DevSecOps integration. The ultimate goal is to integrate vulnerability identification and mitigation processes into the DevSecOps workflow seamlessly. This means providing tools and systems that allow for real-time communication of issues, as well as triggers for remediation actions within the development pipeline. An LLM can help facilitate this integration by automating the creation of tickets, alerts, or tasks in project management systems, CI/CD pipelines, and other DevSecOps tools based on the report's findings.

By using an LLM-based approach, organizations can better streamline the process of turning the technical details of security assessments into actionable plans within their development lifecycle. It also ensures that the communication of security findings is clear, prioritized, and enriches the SBOM with detailed remediation steps. This not only makes the mitigation efforts more efficient but also helps in maintaining compliance, as well as ensuring that security measures evolve alongside the applications and systems they protect.

Real-time feed evaluation for accelerated vulnerability remediation can be performed. In the ever-evolving landscape of cybersecurity, swift detection and timely remediation of vulnerabilities are paramount. To address this challenge, our innovation emphasizes real-time feed evaluation, which significantly reduces the time between detection and remediation, while minimizing the need for manual intervention.

FIG. 13 illustrates an example process 1300 for Real-Time Feed Evaluation, according to some embodiments. In step 1302, process 1300 performs Continuous Data Ingestion. Process 1300 continuously ingests data from a multitude of sources, including threat intelligence feeds, log monitoring systems, penetration testing results, and even external sources like dark web monitoring.

In step 1304, process 1300 performs Data Standardization. Upon ingestion, the data is standardized and normalized to ensure a common format and structure. This standardization facilitates efficient processing and analysis.

In step 1306, process 1300 performs Real-Time Analysis. The core of our innovation lies in real-time analysis. Data is assessed as it arrives, allowing for immediate identification of vulnerabilities, threats, and abnormal activities by evaluating them as a real human like hacker trying to exploit them and confirm the severity and exploitability.

In step 1308, process 1300 performs Automated Correlation. Automated correlation engines process the real-time data, seeking connections and patterns that indicate potential security risks. This includes correlating data across various sources to pinpoint emerging threats.

In step 1310, process 1300 performs Alert Prioritization. Once vulnerabilities or threats are detected, our system employs machine learning algorithms to prioritize alerts based on factors such as severity, asset criticality, and potential impact on the organization by evaluating them in real time like a human does.

Benefits of real-time feed evaluation are now discussed. These can include reduced time lag. By continuously monitoring and assessing data in real time, vulnerabilities and threats are identified as they emerge. This reduces the delay between detection and action. These can include minimized manual intervention. Automation and intelligent prioritization reduce the need for manual assessment and intervention. Security teams can focus on strategic tasks rather than sifting through vast amounts of data. These can include Swift remediation. Vulnerabilities and threats are addressed promptly, as they are detected, ensuring that potential exploits are mitigated quickly. These can include enhanced security posture. A real-time approach bolsters an organization's security posture, as it minimizes the window of opportunity for attackers and limits the potential impact of security incidents.

Real-time feed evaluation represents a significant leap forward in the realm of cybersecurity. By harnessing the power of real-time data analysis, the processes herein empower organizations to stay ahead of emerging threats, respond swiftly to vulnerabilities, and maintain a robust security posture. This approach not only reduces the manual workload on security teams but also ensures that critical security events are addressed promptly, enhancing overall security resilience.

Enhancing software asset management with accurate SBOM and Vulnerability Management is now discussed. It is noted that effective software asset management is crucial for organizations, enabling them to maintain a comprehensive inventory of software components and assess potential vulnerabilities. There can be a focus on improving this process through the integration of accurate Software Bill of Materials (SBOM) and vulnerability management.

Key Components of Accurate SBOM and vulnerability management are now discussed. SBOM and vulnerability management can include user input collection. Users are engaged in the process by providing input about the software components they use. This includes applications, libraries, and dependencies.

SBOM and vulnerability management data can include validation and enrichment. The collected user inputs are validated and enriched with additional data sources. This could include cross-referencing with public SBOM repositories and software version databases.

SBOM and Vulnerability Management can include testing and assessment. Vulnerability assessments and penetration testing are conducted, taking into account the enriched SBOM data. This includes scanning for known vulnerabilities associated with the identified software components.

SBOM and vulnerability management data can include continuous monitoring. Software components are continuously monitored for newly discovered vulnerabilities. The SBOM is updated in real time to reflect the latest status. SBOM and vulnerability management data can include risk scoring. Vulnerabilities are scored based on factors like severity, potential impact, and exploitability. This helps prioritize which vulnerabilities require immediate attention.

SBOM and vulnerability management data can include benefits of accurate SBOM and vulnerability management. SBOM and vulnerability management data can include maintaining a comprehensive software inventory. By involving users in the SBOM creation process, organizations obtain a more complete and accurate software inventory, reducing the risk of overlooking critical components. SBOM and vulnerability management data can include improved vulnerability identification. The enriched SBOM enhances the accuracy of vulnerability identification by providing a clear view of software components and their versions, making it easier to identify known vulnerabilities.

SBOM and vulnerability management data can include effective prioritization. Risk scoring allows organizations to prioritize vulnerabilities efficiently. This ensures that the most critical vulnerabilities are addressed first, reducing exposure to potential threats. SBOM and vulnerability management data can include real-time updates. Real-time monitoring and updates to the SBOM mean that new vulnerabilities are identified and addressed promptly, reducing the window of opportunity for attackers.

This approach to software asset management, SBOM accuracy, and vulnerability management represents a significant advancement in securing an organization's software infrastructure. By combining user input, data validation, and continuous monitoring, we provide a more complete and accurate view of software components and their associated vulnerabilities. This approach empowers organizations to mitigate risks effectively and maintain a robust security posture.

A machine learning engine can utilize machine learning algorithms to recommend and/or optimize various services provided herein. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression and other tasks, which operate by constructing a multitude of decision trees at training time and outputting the class that is the mode of the classes (e.g. classification) or mean prediction (e.g. regression) of the individual trees. RFs can correct for decision trees'habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system) and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

1. A computer-implemented method executed by a specially-configured computing system for improving operation of an automated vulnerability-assessment and penetration-testing technology, the method comprising:
receiving, by a collective-contextual-fusion layer, a heterogeneous security-related data stream comprising a static-analysis result, an interactive-analysis result, a dynamic-analysis result, a threat-intelligence feed, a dark-web or leak-monitoring feed, an SBOM record, a network-telemetry feed, a log-data feed, and cloud-infrastructure information for a protected computing environment;
constructing, by a contextually-adaptive-test-case-selection (CATCS) engine comprising a Bayesian-network model, a multi-objective-optimization module, and an active-learning module, a prioritized list of candidate test-case instructions based on the heterogeneous security-related data stream and on a security-risk model of the protected computing environment;
generating, by an adaptive-and-contextual-payload-preparation (ACPP) engine coupled to the CATCS engine, a tailored attack-payload data structure for each candidate test-case instruction using contextual information comprising at least an application-usage pattern, a deployment-environment attribute, leaked-credential data when available, and threat-intelligence data;
executing, by an exploit-simulation engine operating under an agentic-artificial-intelligence controller, a multi-step exploit-chain instruction against the protected computing environment according to the prioritized list and the tailored attack-payload data structure, the agentic-artificial-intelligence controller autonomously adjusting an exploit sequence and a payload selection in response to runtime-telemetry information collected from the protected computing environment;
performing, by a re-validation module, a verification step of a vulnerability indication produced by the exploit-simulation engine by correlating the runtime-telemetry information with the log-data feed and the network-telemetry feed to algorithmically suppress a false-positive vulnerability indication;
updating, by an SBOM-aware controller, the SBOM record of the protected computing environment with a newly-discovered component and triggering instantiation of an additional candidate test-case instruction corresponding to the updated SBOM record;
transmitting, by the computing system, to a DevSecOps-integration subsystem, a test-result record of the verification step together with a mitigation recommendation generated by the computing system;
and continuously monitoring, by the computing system, a zero-day-vulnerability feed and, upon detecting a relevant zero-day disclosure, dynamically and recurringly triggering execution of a further candidate test-case instruction against a corresponding exposed entry-point of the protected computing environment.

2. The method of claim 1, further comprising expanding an active-reconnaissance coverage by applying a leaked-credential item identified during a passive-reconnaissance phase to authenticate to an additional protected asset of the protected computing environment prior to executing the prioritized list of candidate test-case instructions.

3. The method of claim 1, wherein the active-reconnaissance coverage includes guiding a crawling operation of a web-application target by a machine-learning-based image-recognition module that identifies an interactive element in a single-page-application view to expose a client-side-state change and a hidden attack-surface portion of the protected computing environment.

4. The method of claim 1, further comprising, upon detecting a previously-unseen framework element, a newly-reachable uniform-resource-locator, or a newly-detected database-usage pattern during execution of the prioritized list, dynamically queuing an additional candidate test-case instruction that targets the detected element for immediate inclusion in the prioritized list of candidate test-case instructions.

5. The method of claim 1, wherein the exploit-simulation engine operates under the agentic-artificial-intelligence controller to orchestrate an autonomous multi-stage-exploit sequence, to adapt an exploit strategy to intermediate runtime-telemetry information, and to perform a sandbox-and-rollback operation to limit operational impact during execution of the multi-step exploit-chain instruction.

6. The method of claim 1, wherein the re-validation module applies a correlated-telemetry analysis that combines the vulnerability indication produced by the exploit-simulation engine with a historical-exploit-signature record, the log-data feed, and the network-telemetry feed to algorithmically suppress the false-positive vulnerability indication.

7. The method of claim 1, further comprising supplying a feedback datum from the exploit-simulation engine to the active-learning module of the CATCS engine to refine a future construction of the prioritized list of candidate test-case instructions and a future generation of the tailored attack-payload data structure based on an observed success or an observed failure of the multi-step exploit-chain instruction.

8. The method of claim 1, further comprising generating, by a large-language-model-based reporting engine, a developer-actionable vulnerability-report record that includes a reproducible-step instruction, a risk-based prioritization datum, and a remediation guideline specific to a version identifier and a framework identifier enumerated in the SBOM record.

9. The method of claim 1, further comprising performing a root-cause-analysis procedure that maps a cluster of the vulnerability indication validated by the verification step to an underlying architectural-deficiency pattern, a deprecated-framework identifier, or a systemic security-misconfiguration pattern, and producing a mitigation-plan record that addresses the underlying architectural-deficiency pattern.

10. The method of claim 1, wherein the CATCS engine applies a multi-objective-optimization calculation that balances a vulnerability-coverage metric, an estimated-risk-reduction metric, and a resource-consumption metric when constructing the prioritized list of candidate test-case instructions.

11. A computer-implemented system for automated vulnerability assessment and penetration testing of a protected computing environment, the system comprising:
a collective-contextual-fusion layer configured to receive a heterogeneous security-related data stream comprising a static-analysis result, an interactive-analysis result, a dynamic-analysis result, a threat-intelligence feed, a dark-web or leak-monitoring feed, an SBOM record, a network-telemetry feed, a log-data feed, and cloud-infrastructure information associated with the protected computing environment;
a contextually-adaptive-test-case-selection (CATCS) engine operatively coupled to the collective-contextual-fusion layer, the CATCS engine comprising a Bayesian-network model, a multi-objective-optimization module, and an active-learning module, the CATCS engine being configured to construct a prioritized list of candidate test-case instructions based on the heterogeneous security-related data stream and on a security-risk model of the protected computing environment;
an adaptive-and-contextual-payload-preparation (ACPP) engine operatively coupled to the CATCS engine, the ACPP engine being configured to generate a tailored attack-payload data structure for each candidate test-case instruction using contextual information comprising at least an application-usage pattern, a deployment-environment attribute, leaked-credential data when available, and threat-intelligence data;
an exploit-simulation engine operatively coupled to the ACPP engine and configured to execute a multi-step exploit-chain instruction against the protected computing environment, the exploit-simulation engine being controlled by an agentic-artificial-intelligence controller that is configured to autonomously adjust an exploit sequence and a payload selection in response to runtime-telemetry information collected from the protected computing environment;
a re-validation module operatively coupled to the exploit-simulation engine and configured to perform a verification step of a vulnerability indication produced by the exploit-simulation engine by correlating the runtime-telemetry information with the log-data feed and the network-telemetry feed to algorithmically suppress a false-positive vulnerability indication;
an SBOM-aware controller operatively coupled to the CATCS engine and configured to update the SBOM record of the protected computing environment with a newly-discovered component and to trigger instantiation of an additional candidate test-case instruction corresponding to the updated SBOM record;
a DevSecOps-integration subsystem interface operatively coupled to the re-validation module and configured to receive a test-result record of the verification step together with a mitigation recommendation generated by the system for automated creation of remediation tasks within a DevSecOps pipeline; and
a zero-day-monitoring component operatively coupled to the CATCS engine and configured to continuously monitor a zero-day-vulnerability feed and, upon detecting a relevant zero-day disclosure, to dynamically trigger execution of a further candidate test-case instruction against a corresponding exposed entry-point of the protected computing environment.
